(19) United States
(12) Patent Application Publication
(10) Pub. No.: US 2013/0235566 A1
(43) Pub. Date: Sep. 12, 2013

(54) LIGHTING APPARATUS

(71) Applicant: Eagle FAN, Hsinchu (TW)

(72) Inventor: Eagle FAN, Hsinchu (TW)

(21) Appl. No.: 13/416,237

(22) Filed: Mar. 9, 2012

(51) Int. Cl. F21L 4/04

(52) U.S. Cl. 362/187

(57) ABSTRACT

A lighting apparatus is provided, including a flashlight and a scattering shade. An engagement structure is deposited between the flashlight and the scattering shade for convenient assembly and disassembly. When disassembled, the flashlight emits straight beam for long distance illumination. When assembled, a reflective structure inside the scattering shade can reflect the straight beam from flashlight uniformly to function as a standing light The lighting apparatus also includes various elements, such as, a hook, magnetic element, and so on, so that the lighting apparatus can be used for different lighting purposes.

### FIELD OF THE INVENTION

The present invention generally relates to a lighting apparatus, and more specifically to a portable lighting apparatus

### BACKGROUND OF THE INVENTION

Flashlights are often used in night activities, such as camping, to provide long-distance straight beam lighting for exploring the environment and standing lighting apparatus are used for illuminating the a larger area for activities. Therefore, two types of lighting apparatuses are often required for camping activities. In addition, campers experience inconvenience because of the need to change lighting apparatuses for different purposes, as well as extra weight when packing for camping.

Therefore, it is viable to devise a lighting apparatus able to function as a flashlight as well as a standing light so that a single lighting apparatus can be use for camping needs and relieve the aforementioned inconvenience.

### SUMMARY OF THE INVENTION

The primary object of the present invention is to provide a lighting apparatus able to function as a flashlight and a standing light to cover camping lighting requirements.

To achieve the above object, the present invention provides a lighting apparatus, including a flashlight and a scattering shade. The scattering shade is deposited around the light source of the flashlight and is optionally detachable from the flashlight. Once detached, the flashlight can be used alone to emit long-distance straight beam. The interior of the scattering shade includes a reflective structure. When the flashlight and the scattering shade is assembled, the light emitted from the flashlight, after the reflection by the reflective structure, will scatter uniformly towards the surface of the circumference to form a standing light able to illuminate a space. In this manner, the lighting apparatus can function as a flashlight and a standing light.

Accordingly, another object of the present invention is to provide a lighting apparatus easy for assembly and disassembly. To achieve the above object, the present invention provides an engagement structure between the scattering shade and the flashlight. The engagement structure, for example, can be a snap between protruding lips and circumferential edge, or a screw-bolt structure so that the assembly and the disassembly can be easily and quickly executed.

Yet another object extended from the present invention is to provide a lighting apparatus suitable for placement. To achieve the above object, the present invention provides a scattering shade having top surface as a flat plane so that the lighting apparatus can be placed on top of any flat surface, including, ground, desk top, top of an object, and so on, for maximum coverage area. The present invention also provides another means by including a hook in the top surface of the scattering shade for hanging to a higher or taller object. Yet another means is to deposit a magnetic element at the bottom of the flashlight so as to attach to a metal surface. Another means is to deposit a ring on each side of the bottom edge so that a hanging string and be used to link the two rings for hanging the lighting apparatus.

In summary, the lighting apparatus of the present invention has the advantages of dual functions of a flashlight and a standing light, as well as including a plurality of placement means so that the lighting apparatus can be hanged or placed at a wide range of places for different lighting purposes. In addition, the engagement structure between the flashlight and the scattering shade is easy for assembly and disassembly.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic assembly view of a preferred embodiment of a lighting apparatus according to the invention;

FIG. 2 shows a schematic dissected view of a preferred embodiment of a lighting apparatus of the present invention;

FIG. 3 shows a side view of a preferred embodiment of a lighting apparatus of the present invention; and

FIGS. 4A-4D show schematic views of the lighting apparatus of the present invention in actual applications.

### DETAILED DESCRIPTION OF THE PREFERRED EMBODIMENTS

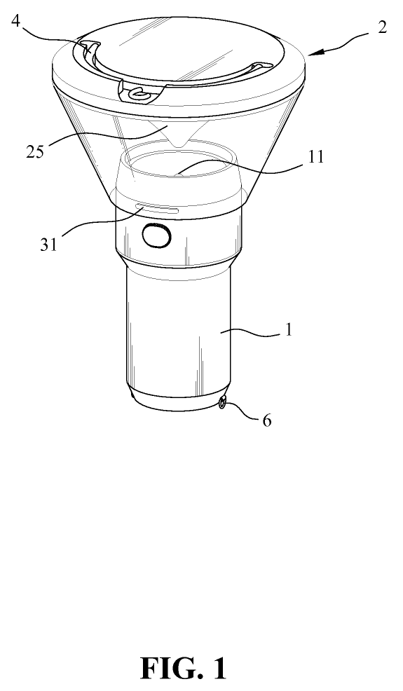

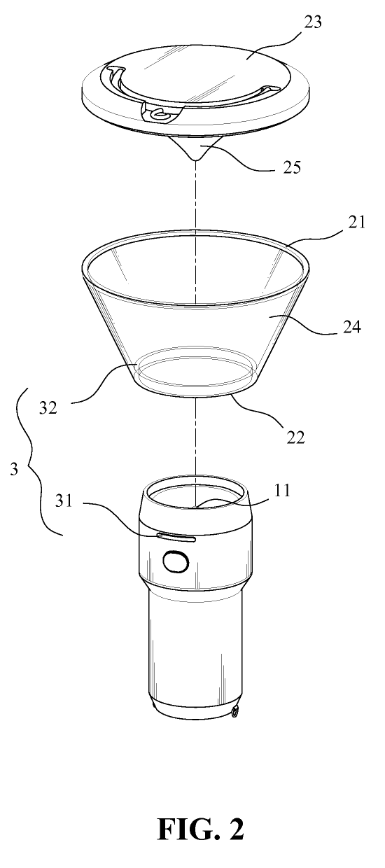

FIG. 1 and FIG. 2 show a schematic assembly view and a dissected view of a preferred embodiment of a lighting apparatus of the present invention. The lighting apparatus of the present invention includes a flashlight 1 and a scattering shade 2. Scattering shade 2 can be optionally detachable to flashlight 1 so that flashlight 1 can emit a straight beam for long-distance lighting purpose. When scattering shade 2 is engaged to flashlight 1, the assembly can be used as a standing light for lighting a surrounding space.

Scattering shade 2 has a conic shape, with a large end 21 with larger diameter and a small end 22 with smaller diameter. Small end 22 is open end and large end 21 is closed. The outer surface closing large end 21 is an opaque surface 23, while surface 24 forming the scattering shade between large end 21 and small end 22 is transparent and/or translucent. Inner surface of large end 21 includes a conic shape reflective structure 25. Surface of reflective structure 25 can be curvy, slanted cone, and so on. Small end 22 is deposited to surround light source 11 of flashlight 1. An engagement structure 3 is deposited between flashlight 1 and scattering shade 2 for assembly and disassembly of the flashlight 1 and scattering shade 2. Engagement structure 3 can include two protruding lips 31 deposited at opposite sides of flashlight 1, and circumferential edges 32 at small end 22 extending towards center. In this manner, when the front end of flashlight 1 is inserted into scattering shade 2, circumferential edges 32 can be stuck to protruding lips 31 to engage flashlight 1 and scattering shade 2. Alternatively, a matching screw-bolt mark pattern (not shown) can be carved to the flashlight surface and the circumference of the scattering shade respectively so that flashlight 1 can be screwed into scattering shade 2 for tight engagement. When scattering shade 2 and flashlight 1 are assembled, the curvy surface of reflective structure 25 faces light source 11 of flashlight 1.

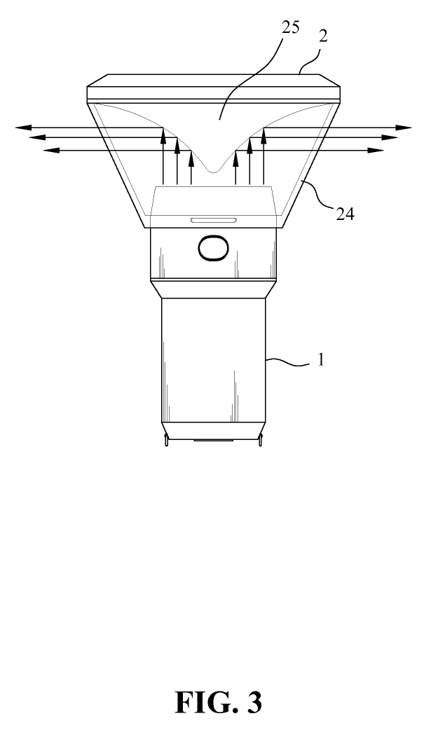

When scattering shade 2 is removed from flashlight 1, flashlight 1 emits a straight beam for long distance illumination. As shown in FIG. 3, when scattering shade 2 is engaged to flashlight 1, the light emitted from light source 11 (as shown in FIG. 2) is reflected by reflective structure 25 uniformly to transparent surface 24 of scattering shade 2, and then through transparent surface 24 to illuminate the surrounding space as a standing light used for camping ground or garden yard, and so on.

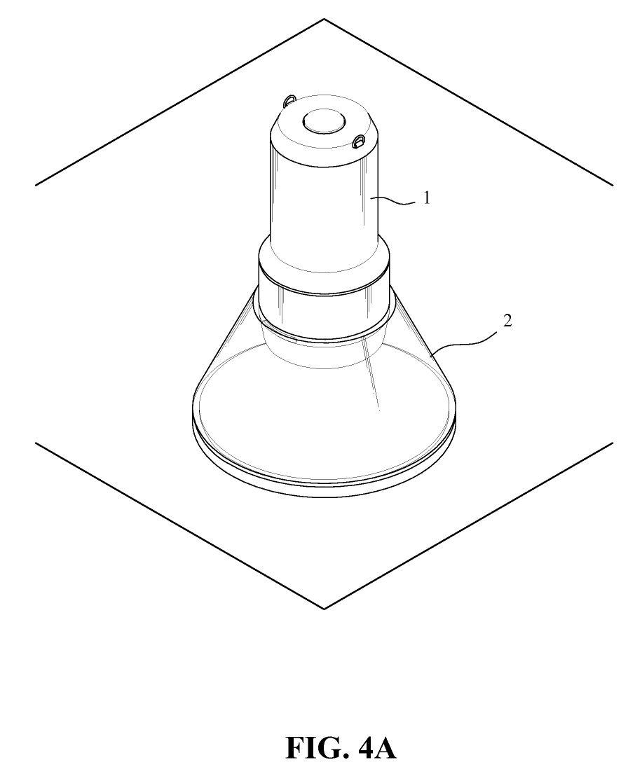

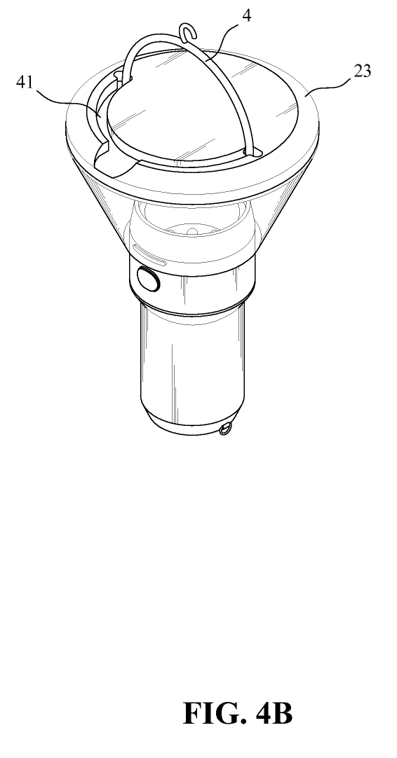

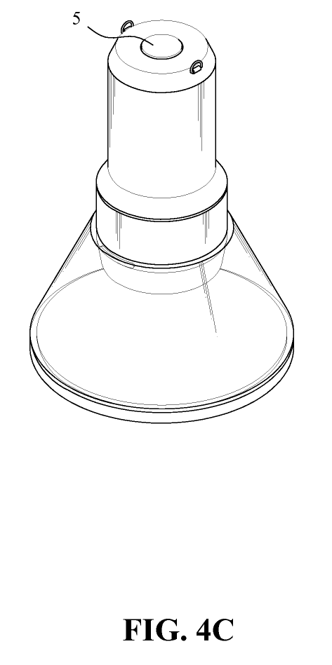

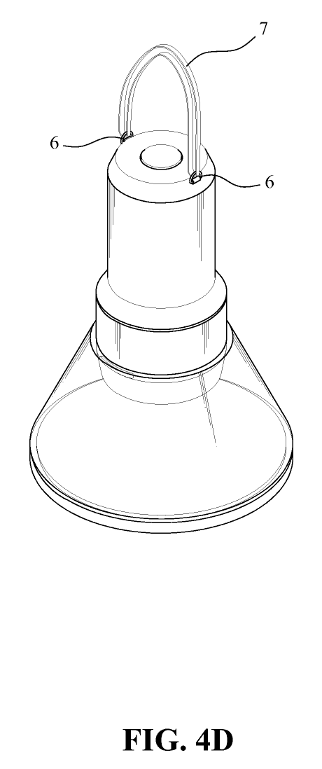

FIGS. 4A-4D show schematic views of the lighting apparatus of the present invention in actual applications. For example, in FIG. 4A, opaque surface 23 is a flat plane and the lighting apparatus can be placed on the ground, desk top or any other flat surfaces vertically for large area illumination. In FIG. 4B, an arc 4 with a hook means is deposited to opaque surface 23 with two ends of arc 4 coupled to opaque surface 32. Arc 4 can be placed flatly on opaque surface 23 or turned vertically for using said hook means for hanging the lighting apparatus to illuminate the surrounding space from above. A concave portion 41 can be included in opaque surface 23 for accommodating arc 4 so that arc 4 can be housed inside concave portion 41 when not in use to keep opaque surface 23 flat. In FIG. 4C, a magnetic element 5 is deposited at the bottom of flashlight 1 for attaching to a metal surface (not shown) to fasten the lighting apparatus. In FIG. 4D, a ring 6 is deposited to two opposite points of bottom of flashlight 1. A hanging string 7 can be used to pass through one or two rings 6 to hang the lighting apparatus for different lighting purpose.

In summary, the lighting apparatus of the present invention has the advantages of dual functions of a flashlight and a standing light, as well as including a plurality of placement means so that the lighting apparatus can be hanged or placed at a wide range of places for different lighting purposes. In addition, the engagement structure between the flashlight and the scattering shade is easy for assembly and disassembly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A lighting apparatus, comprising:
a flashlight;
a scattering shade, deposited to surround a light source of said flashlight, and optionally detachable from said flashlight, said scattering shade further comprising a reflective structure deposited inside to reflect light emitted from said light source to surface of said scattering shade.

2. The lighting apparatus as claimed in claim 1, wherein an engagement structure is deposited between said flashlight and said scattering shade.

3. The lighting apparatus as claimed in claim 1, wherein said reflective structure is conic shape, with a curvy or slanted conic surface facing said light source.

4. The lighting apparatus as claimed in claim 3, wherein said scattering shade is conic shape with a small end engaged to said flashlight surrounding said light source, and a large end having an inner surface deposited with said reflective structure, said large end having an opaque outer surface, and the surface between said small end and said large end is transparent or translucent for the light to pass through.

5. The lighting apparatus as claimed in claim 2, wherein said engagement structure comprises two protruding lips on two opposite points of said flashlight, and circumferential edges on said small end extending towards center so that said circumferential edges can be stuck to said protruding lips for engagement.

6. The lighting apparatus as claimed in claim 4, wherein said outer surface of said large end is a flat surface for vertical placement of said lighting apparatus.

7. The lighting apparatus as claimed in claim 6, wherein an arc with a hook means is deposited on said outer surface for hanging said lighting apparatus.

8. The lighting apparatus as claimed in claim 7, wherein said arc has two ends coupled to said outer surface, and said outer surface comprises a concave portion to accommodate said arc when said arc is not in use.

9. The lighting apparatus as claimed in claim 1, wherein a magnetic element is deposited at bottom of said flashlight.

10. The lighting apparatus as claimed in claim 1, wherein a ring is deposited to two points on bottom edge of said flashlight, and said rings can be connected with a hanging string.
